(19) United States
(12) Patent Application Publication
(10) Pub. No.: US 2026/0175689 A1
(43) Pub. Date: Jun. 25, 2026

(54) WORK VEHICLE

(71) Applicant: Kubota Corporation, Osaka (JP)

(72) Inventors: Yusuke SHOJI, Sakai-shi (JP); Terumasa KOBAYASHI, Sakai-shi (JP); Masayuki NISHIMURA, Sakai-shi (JP); Natsumi WADA, Sakai-shi (JP)

(21) Appl. No.: 19/391,086

(22) Filed: Nov. 17, 2025

(30) Foreign Application Priority Data
Dec. 19, 2024 (JP) 2024-224181

(51) Int. Cl. B60K 37/00; B60K 35/22; B60K 35/81; B62D 1/04; B62D 49/06

(52) U.S. Cl. CPC B60K 37/00; B60K 35/22; B60K 35/81; B62D 1/04; B60K 2360/126; B60K 2360/128; B60K 2360/61; B62D 49/06

(57) ABSTRACT

A work vehicle includes an operation panel facing a driver, a steering post extending from the operation panel toward the driver, a display device provided on the operation panel, and a rotation manual controller provided on the operation panel and operable by the driver.

### CROSS REFERENCE TO RELATED APPLICATIONS

This application claims the benefit of priority to Japanese Patent Application No. 2024-224181 filed on Dec. 19, 2024. The entire contents of this application are hereby incorporated herein by reference.

### BACKGROUND OF THE INVENTION

### 1. Field of the Invention

The present invention relates to work vehicles.

### 2. Description of the Related Art

A work vehicle operated by a driver includes an operation panel near a driver's seat, and the operation panel includes a plurality of manual controllers operable by the driver. Examples of the manual controller include a key switch, a push button switch, and a dial.

The work vehicle disclosed in Japanese Laid-Open Patent Publication No. 2022-26000 includes a display device that displays various types of information, and a dial (rotation manual controller) that receives a rotation operation by a driver.

### SUMMARY OF THE INVENTION

In a case of the work vehicle disclosed in Japanese Laid-Open Patent Publication No. 2022-26000, an operation panel provided with a display device and a rotation manual controller is located on the right side of the driver's seat and is located on the right side for the driver sitting on the driver's seat.

In the work vehicle as described above, the operability can be improved by appropriately positioning the manual controller. In a work vehicle operated by a driver, improvement of operability of an operation panel is a problem.

Therefore, example embodiments of the present invention provide work vehicles capable of improving operability.

A work vehicle includes an operation panel facing a driver, a steering post extending from the operation panel toward the driver, a display device provided on the operation panel, and a rotation manual controller provided on the operation panel and operable by the driver.

With example embodiments of the present invention, operability of an operation panel is improved.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a side view of a work vehicle.

FIG. 2 is a perspective view of a driving unit as viewed from a rear side.

FIG. 3 is a view of the driving unit as viewed from a right side.

FIG. 4 is an explanatory view of an operation panel and a periphery thereof.

FIG. 5 is an explanatory view of a rotation manual controller.

FIG. 6 is an explanatory view illustrating another example of the operation panel.

### DETAILED DESCRIPTION OF THE EXAMPLE EMBODIMENTS

Hereinafter, an outline of example embodiments of the present invention will be listed and described.

(1) A work vehicle of the present example embodiment includes an operation panel facing a driver, a steering post extending from the operation panel toward the driver, a display device provided on the operation panel, and a rotation manual controller provided on the operation panel and operable by the driver.

The operation panel faces the driver and is located in front of the driver. The display device and the rotation manual controller are provided on the operation panel, so that operability of the operation panel is improved.

(2) In the work vehicle according to (1), the steering post is located closer to the driver than the display device. The rotation manual controller is located on one side of the steering post in a left-right direction.

In the operation panel, the operability of the rotation manual controller is improved.

(3) In the work vehicle according to (1) or (2), a different manual controller from the rotation manual controller is located on one side of the steering post in a left-right direction. The rotation manual controller is located farther from the steering post than the different manual controller.

In the operation panel, the operability of the rotation manual controller is improved.

(4) The work vehicle according to any one of (1) to (3) includes a handle provided on a tip portion side of the steering post. At least a portion of the rotation manual controller is located between a virtual vertical plane passing through one end of the handle in a left-right direction and spreading in a front-rear direction and one end of the operation panel in the left-right direction.

Normally, the driver often grips the handle to operate the work vehicle. According to the above configuration, the driver can operate the rotation manual controller by lowering his/her hand (right hand or left hand) from the handle. The operability of the rotation manual controller is improved.

(5) In the work vehicle according to any one of (1) to (4), the rotation manual controller is usable to change display of the display device.

The driver can operate the rotation manual controller while checking the display content of the display device.

(6) In the work vehicle according to any one of (1) to (5), the operation panel is provided with a plurality of manual controllers operable by the driver. The rotation manual controller is located outermost in a left-right direction on the operation panel among the plurality of manual controllers including the rotation manual controller.

The operation of the rotation manual controller is less likely to be disturbed by other manual controllers or operation devices.

(7) In the work vehicle according to any one of (1) to (6), the rotation manual controller includes a dial and push buttons located adjacent to the dial.

The driver easily performs a rotation operation of the dial and an operation of the push button performed in association with the rotation operation.

(8) In the work vehicle according to (7), the push buttons are located side by side adjacent to one side of the dial in a left-right direction.

When the driver operates the rotation manual controller with his/her right hand (or left hand), the dial can be operated with the thumb and the index finger, and the push button can be operated with the middle finger or the ring finger, so that the movement of his/her hand can be reduced.

(9) In the work vehicle according to any one of (1) to (8), the operation panel includes a first surface on which the display device is provided and a second surface that is located closer to the driver than the first surface and on which the rotation manual controller is provided. Regarding an inclination angle using a horizontal plane as a reference, the first surface has a larger inclination angle than the second surface.

The driver can operate the rotation manual controller with his/her right hand relaxed while visually recognizing the display device.

(10) In the work vehicle according to any one of (1) to (9), the rotation manual controller is located on one side in a left-right direction with respect to the display device and closer to the driver than the display device.

The driver can easily check both the display device and the rotation manual controller. It is easy to operate the rotation manual controller while visually recognizing the display device.

(11) In the work vehicle according to any one of (1) to (10), the rotation manual controller is located at a position to one side one side in a left-right direction from the steering post located at a center of the operation panel in a left-right direction.

The operation of the rotation manual controller is less likely to be disturbed by the steering related operation device.

(12) The work vehicle according to any one of (1) to (11) includes a second manual controller provided on the operation panel and different from the rotation manual controller. The second manual controller is located in a region of the operation panel on one side in a left-right direction with respect to the steering post. The rotation manual controller is closer to the display device than the second manual controller.

In a case where the operation frequency of the rotation manual controller is higher than that of the second manual controller, the above configuration is preferable.

(13) The work vehicle according to any one of (1) to (12) includes a cruise lever provided on the operation panel and configured to control a traveling speed. The rotation manual controller has a function of performing an operation of adjusting a rotation speed of a drive assembly. The rotation manual controller and the cruise lever are located in a region on one side in a left-right direction with respect to the steering post located at a center of the operation panel in a left-right direction.

The manual controller of a drive system is located in a region on one side in the left-right direction, and the operability is improved.

(14) The work vehicle according to (13) includes an on/off manual controller provided on the operation panel and configured to control on/off of the drive assembly. The on/off manual controller is located in the region on one side in the left-right direction.

The manual controllers related to the driving operation of the work vehicle are collected in the region on one side of the operation panel in the left-right direction, and the operability is improved.

(15) The work vehicle according to any one of (1) to (14) includes an on/off manual controller provided on the operation panel and configured to control on/off of a drive assembly. When viewed from a direction orthogonal to the operation panel, the on/off manual controller is located in a region between a circumscribed circle of a handle provided on a tip portion side of the steering post and the steering post.

The on/off manual controller is located to be hidden by the handle. It is possible to reduce or prevent an erroneous operation of the on/off manual controller during driving.

(16) The work vehicle according to any one of (1) to (15) includes an on/off manual controller provided on the operation panel and configured to control on/off of a drive assembly. The on/off manual controller is located closer to a driver than the rotation manual controller.

The on/off manual controller is close to the driver, and the on/off manual controller can be operated in an emergency.

(17) The work vehicle according to any one of (1) to (16) includes an on/off manual controller provided on the operation panel and configured to control on/off of a drive assembly. The on/off manual controller is located closer to the steering post than the rotation manual controller.

The on/off manual controller is located to be hidden by the handle. It is possible to reduce or prevent an erroneous operation of the on/off manual controller during driving.

Hereinafter, example embodiments of the present invention will be described in detail with reference to the drawings. Note that at least some of the example embodiments described below may be arbitrarily combined.

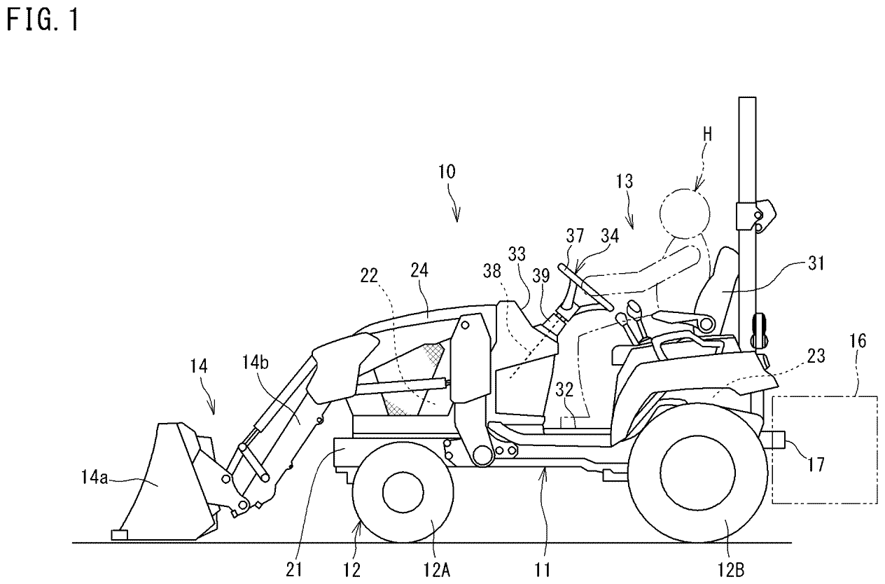

FIG. 1 is a side view of a work vehicle. A work vehicle 10 illustrated in FIG. 1 is a vehicle used for farmwork, and is specifically a small tractor. Note that work vehicles according to example embodiments of the present invention are not limited to the tractor, and may be vehicles such as construction machines or utility vehicles.

In the present disclosure, a direction in which the work vehicle 10 moves forward (left direction in the case of FIG. 1) is defined as a front, a direction in which the work vehicle 10 moves backward is defined as a rear, a left side of the work vehicle 10 facing forward is defined as a left, and a right side of the work vehicle 10 facing forward is defined as a right. The front, rear, left, and right directions are the same as the front, rear, left, and right directions for a driver (user) sitting on a driver's seat 31 included in the work vehicle 10. The left-right direction is the width direction of the work vehicle 10, that is, the vehicle-width direction.

The work vehicle 10 includes a vehicle main body 11, a traveling device 12, and a driving unit 13. The work vehicle 10 illustrated in FIG. 1 further includes a work device 14 and a controller.

The vehicle main body 11 includes a body frame 21 serving as a frame of the vehicle, a drive assembly 22, a gear box 23, and a front hood 24. The drive assembly 22 is a power source of the work vehicle 10, and may be an electric motor or an engine. The gear box 23 operates according to the operation of a driver H, changes the rotational speed of the output shaft of the drive assembly 22, and changes the traveling direction of the work vehicle 10 back and forth. The traveling device 12 is operated by the power generated by the drive assembly 22, and the work vehicle 10 travels.

In the non-limiting example of the work vehicle 10 illustrated in FIG. 1, the work device 14 is a loader, and the work device 14 is mounted on the front portion of the body frame 21. The loader causes a hydraulic actuator to swing a bucket 14a and a boom 14b. The work device 14 may be a device other than the loader.

Another work device 16 can be connected to a rear portion of the vehicle main body 11. The work device 16 is replaceable, and various work devices 16 can be coupled to the vehicle main body 11 according to the work content. The vehicle main body 11 includes a PTO shaft (power take-off shaft) 17. The PTO shaft 17 is one of output shafts of the gear box 23, and is rotated by power from the drive assembly 22. The work device 16 can receive power (rotational force) from the PTO shaft 17 and operate. The work device 16 is, for example, a mower, and the mower operates by the rotation of the PTO shaft 17.

The traveling device 12 supports the vehicle main body 11 in a travelable manner. The traveling device 12 includes left and right front wheels 12A and left and right rear wheels 12B. The front wheel 12A and the rear wheel 12B are rotationally driven by receiving power from the drive assembly 22. The front wheel 12A and the rear wheel 12B are not limited to tires, and may be other forms such as crawlers.

The driving unit 13 is provided on the vehicle main body 11. The driving unit 13 includes the driver's seat 31, a driving floor 32, an operation panel 33, and a steering device 34.

The driver's seat 31 is a portion on which the driver H who drives and operates the work vehicle 10 sits. The driving floor 32 is located in front of and below the driver's seat 31. The driving floor 32 is a portion on which the driver H sitting on the driver's seat 31 places his/her foot. An operation pedal (not illustrated) that can be operable by the driver H sitting on the driver's seat 31 with his/her foot is provided on the driving floor 32.

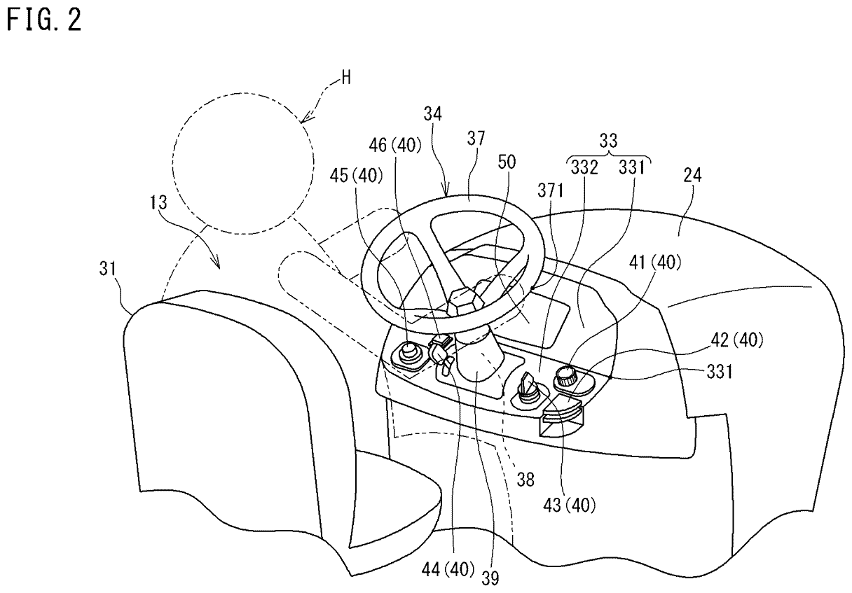

The operation panel 33 is located in front of the driver's seat 31. The operation panel 33 is provided at a position facing the driver H (particularly, his/her face) sitting on the driver's seat 31. The operation panel 33 includes a plurality of manual controllers 40 (see FIG. 2) manually operable by the driver H. The operation panel 33 is also referred to as an instrument panel. The operation panel 33 and the manual controller 40 will be described later.

The steering device 34 includes a handle 37, a steering shaft 38, and a steering post 39. The handle 37 is located in front of the driver's seat 31 and above the driving floor 32. The handle 37 of the present example embodiment has an annular shape and is also referred to as a steering wheel. The steering shaft 38 is connected to the handle 37 and is rotated by an operation of the handle 37. By the rotation of the steering shaft 38, the direction in which the wheels (front wheels 12A) roll is changed, and the traveling direction of the work vehicle 10 in the left-right direction is changed.

The steering post 39 surrounds the steering shaft 38, and extends from a portion of the operation panel 33 toward the driver H sitting on the driver's seat 31. The steering post 39 is also referred to as a steering column. The handle 37 is located closer to the driver H than the operation panel 33, that is, closer to the driver's seat 31. In a case of the present example embodiment, the steering device 34 includes a tilt mechanism, and can swing the steering shaft 38 between the upper front position and the lower rear position to change the position of the handle 37.

The controller is a computer device including a processor such as a central processing unit (CPU) and a memory, and is, for example, a micro controller unit (MCU). In the controller, the processor is configured or programmed to perform various operations and processes according to a computer program stored in the memory. As a result, each structural element or functional unit (for example, the drive assembly 22 or the display panel 33) of the work vehicle 10 is controlled.

FIG. 2 is a perspective view of the driving unit 13 as viewed from the rear side. The operation panel 33 includes a display device 50. The display device 50 is an output interface that displays information such as a state of the work vehicle 10 or a predetermined value to the driver H according to the output of the controller. The display device 50 is, for example, a monitor using a liquid crystal, and displays and outputs various types of information. In order to change the display of the display device 50, a rotation manual controller 41 to be described later is used. The display device 50 is located at the center of the operation panel 33 in the left-right direction.

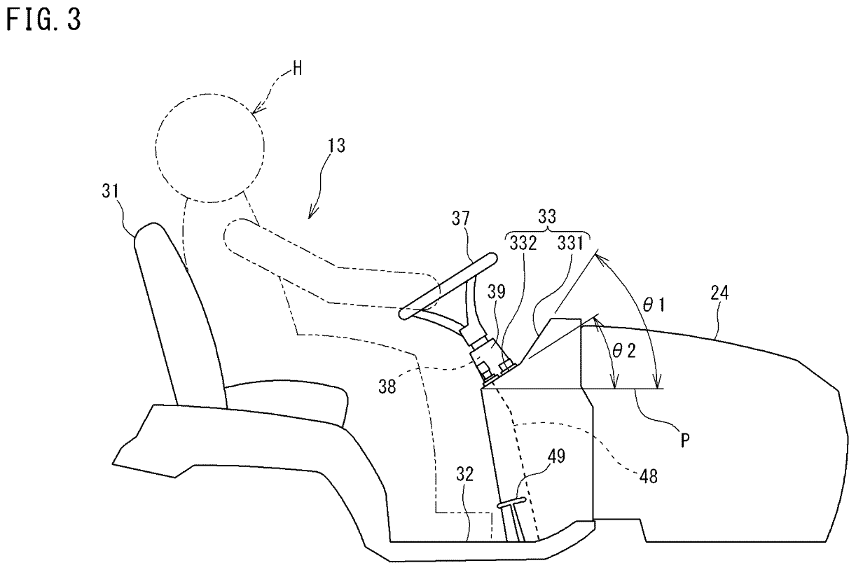

FIG. 3 is a view of the driving unit 13 as viewed from the right side. As illustrated in FIG. 2 and FIG. 3, the operation panel 33 includes a first surface 331 on which the display device 50 is provided, and a second surface 332 located closer to the driver H than the first surface 331. The position on the driver H side is the position on the driver's seat 31 side. Each of the first surface 331 and the second surface 332 may partially have an uneven shape for the manual controller 40, but has a flat surface as a whole.

Regarding an inclination angle θ using a horizontal plane P as a reference, the first surface 331 has a larger inclination angle than the second surface 332. In FIG. 3, the inclination angle of the first surface 331 is “θ1”, the inclination angle of the second surface 332 is “θ2”, and θ1>θ2.

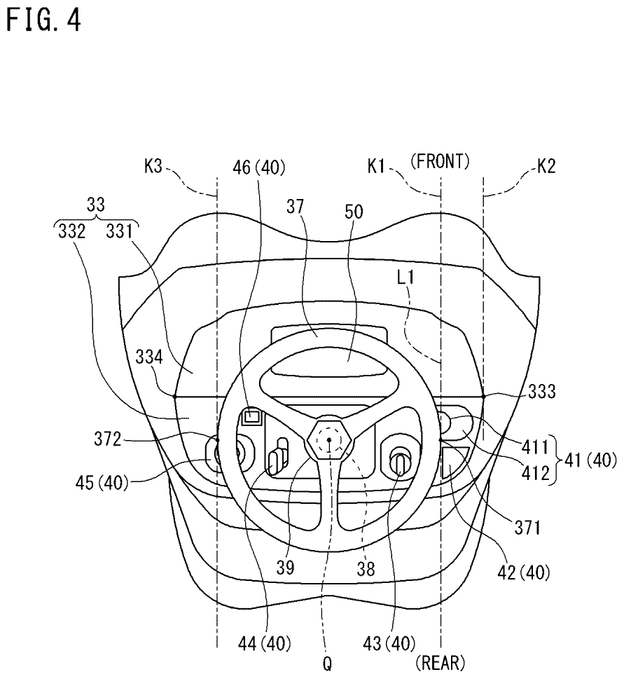

FIG. 4 is an explanatory view of the operation panel 33 and a periphery thereof. FIG. 4 is a view when viewed from a direction orthogonal to the second surface 332 of the operation panel 33. FIG. 3 and FIG. 4 illustrate a state in which the center line of the steering shaft 38 is orthogonal to the second surface 332.

The operation panel 33 includes the plurality of manual controllers 40 manually operable by the driver H. Each manual controller 40 is an input interface that receives an operation by the driver H. When the operation panel 33 is viewed from above the driver's seat 31, the operation panel appears as illustrated in FIG. 4, and when the driver H sitting on the driver's seat 31 views the operation panel 33, the operation panel appears approximately as illustrated in FIG. 4.

The plurality of manual controllers 40 includes the rotation manual controller 41, a cruise lever 42, an on/off manual controller 43, a tilt lever 44, a combination switch 45, and a stationary PTO switch 46. The rotation manual controller 41, the cruise lever 42, the on/off manual controller 43, the tilt lever 44, the combination switch 45, and the stationary PTO switch 46 are provided on the second surface 332 of the operation panel 33. The display device 50 is provided on the first surface 331 of the operation panel 33.

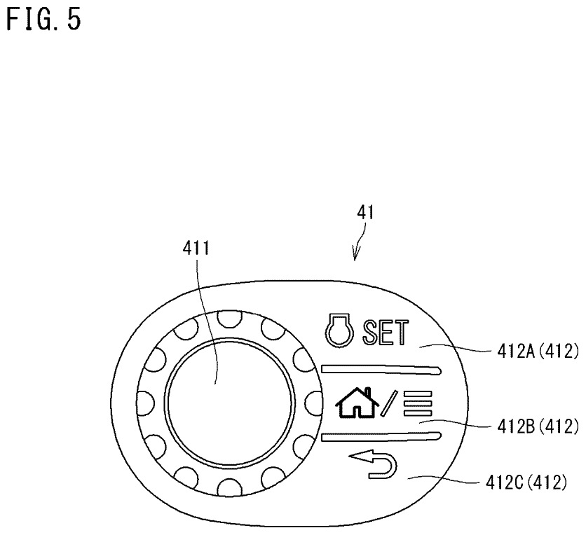

FIG. 5 is an explanatory view of the rotation manual controller 41. The rotation manual controller 41 includes one dial 411 and a plurality of push buttons 412. The dial 411 is a jog dial that receives a rotation operation by the driver H. The push buttons 412 are button switches that receive a push operation by the driver H.

The push buttons 412 are located adjacent to the dial 411. Therefore, the driver H can easily perform the rotation operation of the dial 411 and the operations of the push buttons 412 performed in association with the rotation operation.

The push buttons 412 are located side by side on the right side of the dial 411. In the case of the present example embodiment, three push buttons 412 are located side by side in the front-rear direction adjacent to the dial 411, for example. When the driver H operates the rotation manual controller 41 with his/her right hand, the dial 411 can be operated with the thumb and the index finger, and the push buttons 412 can be operated with the middle finger or the ring finger, so that the movement of his/her hand can be reduced.

An example of a function of the rotation manual controller 41 will be described. The rotation manual controller 41 is used to change the display of the display device 50 and also has a function of performing an operation of adjusting the rotation speed of the drive assembly 22.

When the driver H rotates the dial 411 clockwise, the controller increases the rotation speed of the drive assembly 22 according to the amount (rotation angle) of the rotation operation. In accordance with this rotation operation, information on the rotation speed is displayed on the display device 50, and the driver H can confirm the rotation speed. The rotation speed of the drive assembly 22 affects the traveling speed of the work vehicle 10, the rotation speed of the PTO shaft 17, or the operation speed of the work devices 14 and 16.

In the case of the present example embodiment, a frequently used rotation speed (for example, the idling rotational speed or the maximum rotational speed) among the rotation speeds of the drive assembly 22 is set in the controller in advance as a default value. The display device 50 displays the plurality of default values side by side. One default value of the plurality of default values is displayed as a selection candidate (for example, displayed in a thick frame), and the default values displayed as the selection candidate (for example, displayed in a thick frame) are sequentially switched by rotating the dial 411. That is, the dial 411 is used to select one default value from the plurality of default values.

In a state where one default value is selected, one default value can be determined by pressing the dial 411 also having a function as a push button. When one default value is determined, the controller is configured or programmed to perform control to match the rotation speed of the drive assembly 22 with the determined default value.

In the case of the present example embodiment, three push buttons 412 are provided, for example. The three push buttons 412 (412 A, 412B, 413C) are positioned side by side from a side far from the driver H toward a side close to the driver H (from front to rear), and different functions are assigned to the push buttons. The first push button 412A has a preset function such as calling preset information. The second push button 412B has a function of switching between the home screen and the function screen in the display device 50. The third push button 413C has a function of returning to the previous screen in the display device 50.

Note that such functions of the rotation manual controller 41 are examples, and can be used for various purposes.

The cruise lever 42 will be described. An accelerator pedal 49 is provided on the driving floor 32 as an operation pedal that can be operated by the foot of the driver H sitting on the driver's seat 31 (see FIG. 3). The operation of the accelerator pedal 49 activates the work vehicle 10 and changes the traveling speed of the work vehicle 10.

The cruise lever 42 is connected, via a power transmission 48, to a movable mechanism unit (not illustrated) linked with the accelerator pedal 49. When the driver H performs a pulling-up operation, the cruise lever 42 is held as it is. When the cruise lever 42 is pulled up, the state of the movable mechanism unit is maintained, and the traveling speed of the work vehicle 10 is kept constant. As a result, the work vehicle 10 can travel at a constant speed without the driver H continuously stepping on the accelerator pedal. As described above, the cruise lever 42 is a lever type switch to control the traveling speed.

The on/off manual controller 43 is an ignition key, and functions as a switch (key switch) to control on/off of the drive assembly 22. By rotating the on/off manual controller 43 in the first direction, the drive assembly 22 is turned on. In a case where the drive assembly 22 includes a motor, when being turned on, the drive assembly 22 enters a standby state in which a drive current can flow through the motor. Thereafter, the motor is rotationally driven according to the operation of the accelerator pedal, and the traveling of the work vehicle 10 is started.

When the on/off manual controller 43 is rotated in the second direction opposite to the first direction, the drive assembly 22 is turned off. In the off state, the vehicle is in a stop state in which the drive current cannot flow to the motor.

The tilt lever 44 will be described. As described above, the position of the handle 37 can be changed by the tilt mechanism. By moving the tilt lever 44 in the first direction, the handle 37 and the steering shaft 38 are brought into a free movable state in the tilt mechanism. The handle 37 is adjusted to a desired position in the free state. When the tilt lever 44 is moved in the second direction opposite to the first direction, the handle 37 and the steering shaft 38 are not movable in the tilt mechanism.

The combination switch 45 includes a plurality of push button switches. Although not illustrated, the work vehicle 10 includes a direction indicator, an emergency blinking light, and a headlight. The combination switch 45 is a manual controller to operate the direction indicator to indicate a change in a traveling course, turning on and off the emergency blinking light, and turning on and off the headlight. The combination switch 45 is an auxiliary switch to assist vehicle traveling.

The stationary PTO switch 46 will be described. As described above, the work vehicle 10 includes the PTO shaft 17. The work vehicle 10 is configured such that a sensor is provided on the driver's seat 31, and the PTO shaft 17 does not rotate unless the driver H sits on the driver's seat 31. Exceptionally, it may be necessary to rotate the PTO shaft 17 in a state where the driver H stands beside the work vehicle 10, for example. At this time, when the stationary PTO switch 46 is operated, the PTO shaft 17 is exceptionally rotatable, that is, the rotation of the PTO shaft 17 is exceptionally permitted. Note that a changeover switch for rotation and stop (on and off) of the PTO shaft 17 is provided in the vehicle main body 11 (fender).

The arrangement of the plurality of manual controllers 40 will be described.

As illustrated in FIG. 4, the manual controller 40 included in the work vehicle 10 of the present example embodiment includes the operation panel 33 facing the driver H, the steering post 39 extending from the operation panel 33 toward the driver H, the display device 50 provided on the operation panel 33, and the rotation manual controller 41 provided on the operation panel 33 and operable by the driver H. The operation panel 33 faces the driver H sitting on the driver's seat 31 and facing the front, and is located in front of the driver H. The operation panel 33 is provided with the plurality of manual controllers 40 including the display device 50 and the rotation manual controller 41. Therefore, the operability of the operation panel 33 is high.

The steering post 39 is located closer to the driver H (driver's seat 31 side) than the display device 50. The rotation manual controller 41 is located on the right side which is one side of the steering post 39 in the left-right direction.

On the right side of the steering post 39, the on/off manual controller 43 is located as the manual controller 40 different from the rotation manual controller 41. In a case where an intersection between the upper surface of the operation panel 33 (second surface 332) and the center line of the steering post 39 is set as a reference Q and a two-dimensional coordinate system is set on a plane including the upper surface, the rotation manual controller 41 is located farther from the reference Q than the on/off manual controller 43. That is, the rotation manual controller 41 is located farther from the steering post 39 than the on/off manual controller 43.

As illustrated in FIG. 4, at least a portion of the rotation manual controller 41 is located between a virtual vertical plane K1 passing through a right end 371 of the handle 37 and spreading in the front-rear direction and a right end 333 of the operation panel 33. In the case of the present example embodiment, a right half or more of the rotation manual controller 41 is located between the virtual vertical plane K1 and the right end 333 of the operation panel 33. Assuming that the virtual vertical plane K1 is a “first virtual vertical plane K1” and a virtual vertical plane that passes through the rightmost end 333 of the operation panel 33 and spreads in the front-rear direction is a “second virtual vertical plane K2”, at least a portion of the rotation manual controller 41 is located between the first virtual vertical plane K1 and the second virtual vertical plane K2 on the operation panel 33.

The rotation manual controller 41 is provided across an intersection line L1 between the first virtual vertical plane K1 and the operation panel 33 (second surface 332). Since FIG. 4 is a view of the operation panel 33 as viewed from the driver H side, that is, as viewed in plan view, the first virtual vertical plane K1 coincides with the intersection line L1 as illustrated in FIG. 4.

The rotation manual controller 41 is provided in a range within the width dimension of the palm, specifically, within about 20 cm from the intersection line L1 to the right, for example.

In the case of the present example embodiment, the dial 411 included in the rotation manual controller 41 is located at a position overlapping the intersection line L1.

Alternatively, the rotation manual controller 41 may be located on the right side of the configuration illustrated in FIG. 4. That is, the entire rotation manual controller 41 may be provided in a region on the right side of the intersection line L1 between the first virtual vertical plane K1 and the operation panel 33 (second surface 332).

Normally, the driver H often grips the handle 37 to operate the work vehicle.

Therefore, according to the position of the rotation manual controller 41 as described above, the driver H can operate the rotation manual controller 41 by lowering his/her hand (right hand) from the handle 37. The operability of the rotation manual controller 41 is good.

As described above, the rotation manual controller 41 is used to change the display on the display device 50. Therefore, the driver H can operate the rotation manual controller 41 while checking the display content of the display device 50, and can easily perform the operation.

The plurality of manual controllers 40 is provided on the operation panel 33. The rotation manual controller 41, the cruise lever 42, and the on/off manual controller 43 are located in a right-half region of the operation panel 33. The steering post 39 is located at the center of the operation panel 33 in the left-right direction. The rotation manual controller 41, the cruise lever 42, and the on/off manual controller 43 are located in a region on the right side of the steering post 39.

In the right-half region of the operation panel 33, the rotation manual controller 41 and the cruise lever 42 are located on the outermost side (right outer side) in the left-right direction. That is, the rotation manual controller 41 is one of the manual controllers 40 located on the outermost side (in the case of the present example embodiment, the right outer side) in the left-right direction on the operation panel 33 among the plurality of manual controllers 40.

The rotation manual controller 41 is operated more frequently than the cruise lever 42 and the on/off manual controller 43 located on the same right side. Since the rotation manual controller 41 is located on the outer side (right outer side) in the left-right direction, the operation of the rotation manual controller 41 is less likely to be disturbed by the other manual controllers 40 or operation devices (for example, the handle 37).

As described with reference to FIG. 3, the operation panel 33 includes the first surface 331 on which the display device 50 is provided and the second surface 332 located closer to the driver H than the first surface 331. The rotation manual controller 41 is provided on the second surface 332. Regarding the inclination angle θ using the horizontal plane P as a reference, the first surface 331 has a larger inclination angle than the second surface 332 (θ1>θ2). Thus, the driver H can operate the rotation manual controller 41 with his/her right hand relaxed while visually recognizing the display device 50.

The rotation manual controller 41 is located on the right side of the display device 50 and closer to the driver H than the display device 50, that is, on the driver's seat 31 side. The driver H can easily check both the display device 50 and the rotation manual controller 41. The driver H can easily operate the rotation manual controller 41 while visually recognizing the display device 50.

In particular, as described above, the operation panel 33 includes the first surface 331 and the second surface 332 having the bending angle, the display device 50 is provided on the first surface 331, and the rotation manual controller 41 is provided on the second surface 332, so that both the display device 50 and the rotation manual controller 41 can be easily checked.

The rotation manual controller 41 is located at a position away to the right from the steering shaft 38 (steering post 39) located at the center of the operation panel 33 in the left-right direction. Moreover, the rotation manual controller 41 is located closer to the driver H than the display device 50.

Since the rotation manual controller 41 is located at a position away to the right from the steering shaft 38 and the steering post 39, the operation of the rotation manual controller 41 is less likely to be disturbed by the steering related operation devices, that is, the handle 37, the steering shaft 38, and the steering post 39.

In the right region of the operation panel 33, the plurality of manual controllers 40 includes the cruise lever 42 and the on/off manual controller 43 as a second manual controller different from the rotation manual controller 41. The cruise lever 42 and the on/off manual controller 43 (second manual controller) are located in a region of the operation panel 33 on the right side of the steering shaft 38 (steering post 39). Then, the rotation manual controller 41 is closer to the display device 50 than the cruise lever 42 and the on/off manual controller 43 (second manual controller). As described above, since the operation frequency of the rotation manual controller 41 is higher than those of the cruise lever 42 and the on/off manual controller 43, the above arrangement is preferable.

The rotation manual controller 41 and the cruise lever 42 are located in a region on the right side of the steering shaft 38 (steering post 39) located at the center of the operation panel 33 in the left-right direction.

As described above, the rotation manual controller 41 and the cruise lever 42 function as manual controllers of a drive system (traveling system). Since such manual controllers are collectively located in the right region, the operability related to the drive system (traveling system) is high.

The on/off manual controller 43 is located in the right region of the operation panel 33. The on/off manual controller 43, the rotation manual controller 41, and the cruise lever 42 function as manual controllers related to the driving operation of the work vehicle 10. Since such manual controllers are collected in the right region of the operation panel 33, the operability related to the driving operation of the work vehicle 10 is high.

As illustrated in FIG. 4, when viewed from a direction orthogonal to the second surface 332 of the operation panel 33, the on/off manual controller 43 is located in a region between a circumscribed circle of the handle 37 and the steering shaft 38 (steering post 39). In the case of the present example embodiment, since the handle 37 is circular, the circumscribed circle thereof coincides with the outer peripheral edge shape of the handle 37. In the case of the present example embodiment, the entire on/off manual controller 43 is located in a region between the circumscribed circle of the handle 37 and the steering shaft 38 (steering post 39). The on/off manual controller 43 is located to be hidden by the handle 37. It is possible to reduce or prevent an erroneous operation of the on/off manual controller 43 during driving.

The on/off manual controller 43 is located closer to the driver than the rotation manual controller 41. The on/off manual controller 43 is located closer to the steering shaft 38 (steering post 39) than the rotation manual controller 41. The on/off manual controller 43 is close to the driver H (driver's seat 31), and the on/off manual controller 43 can be easily operated in an emergency.

The positioning of the manual controllers 40 in a left region of the operation panel 33 will be described. The tilt lever 44, the combination switch 45, and the stationary PTO switch 46 are located in the left region of the operation panel 33.

The tilt lever 44 is located close to the steering post 39. The combination switch 45 is provided on the left side of the tilt lever 44.

At least a portion of the combination switch 45 is located between a third virtual vertical plane K3 passing through a left end 372 of the handle 37 and spreading in the front-rear direction and a left end 334 of the operation panel 33. Normally, the driver H often grips the handle 37 to operate the work vehicle. Therefore, according to the position of the combination switch 45 as described above, the driver H can operate the combination switch 45 by lowering his/her hand (left hand) from the handle 37. The operability of the combination switch 45 is improved.

The stationary PTO switch 46 is located closer to the display device 50 than the tilt lever 44 and the combination switch 45. As illustrated in FIG. 4, when viewed from a direction orthogonal to the second surface 332 of the operation panel 33, the stationary PTO switch 46 and the tilt lever 44 are located in a region between the circumscribed circle of the handle 37 and the steering shaft 38 (steering post 39).

In the case of the configuration illustrated in FIG. 4, in the operation panel 33, the display device 50 is provided on the first surface 331, and the rotation manual controller 41 and the other manual controllers 40 are provided on the second surface 332. The rotation manual controller 41 may be provided on the first surface 331.

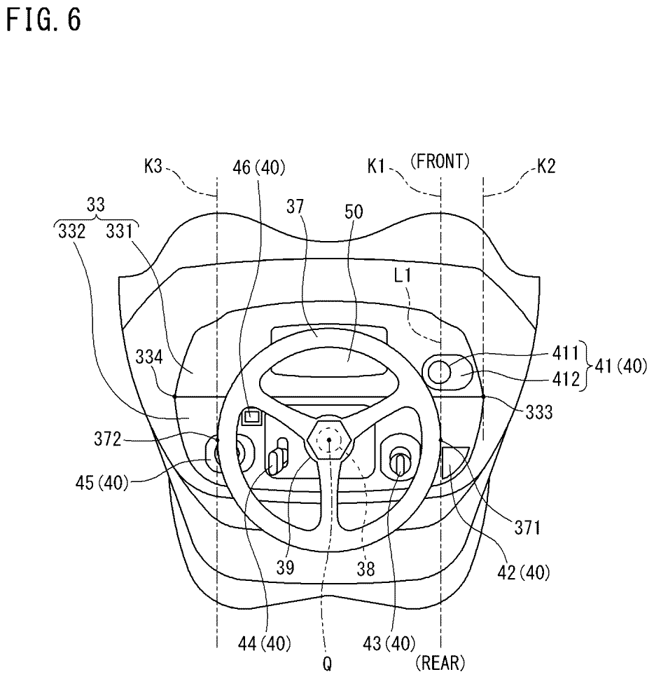

That is, FIG. 6 is an explanatory view illustrating another configuration of the operation panel 33. In the configuration illustrated in FIG. 6, the operation panel 33 includes the first surface 331 and the second surface 332 located closer to the driver H than the first surface 331, and the display device 50 and the rotation manual controller 41 are provided on the first surface 331. Note that, in addition to the rotation manual controller 41, one or a plurality of other manual controllers 40 may be provided on the first surface 331. Furthermore, in FIG. 6, another manual controller 40 may be provided on the first surface 331 instead of the rotation manual controller 41. The display device 50 and one or a plurality of manual controllers 40 may be provided on the first surface 331.

As described above, in the case of the present example embodiment, the case where the plurality of manual controllers 40 is provided on the operation panel 33 has been described. However, all of the manual controllers 40 described above may not necessarily be provided on the operation panel 33, and one or the plurality of manual controllers 40 may be omitted.

The structure or configuration of each manual controller 40 can be changed into a switch type or a lever type.

The positioning of the plurality of manual controllers 40 provided on the operation panel 33 may be opposite in the left-right direction. In a case where the arrangement or positioning is reversed, “right” is read as “left” and “left” is read as “right” in each of the above descriptions.

The above example embodiments are illustrative in all respects and are not restrictive. The scope of the present invention is defined not by the example embodiments but by the claims, and includes all modifications, combinations, substitutions, etc., within the scope equivalent to the configuration described in the claims.

Example embodiments of work vehicles of the present disclosure include the configurations described below. In addition, each of the following example embodiments can have at least a portion of each configuration described with reference to FIG. 1 to FIG. 6.

[1] The work vehicle 10 includes the handle 37 provided on the tip portion side of the steering post 39. At least a portion of the rotation manual controller 41 is located between the virtual vertical plane K1 that passes through the end (right end 371) on one side of the handle 37 in the left-right direction and spreads in the front-rear direction and the end (right end 333) on one side of the operation panel 33 in the left-right direction.

Normally, the driver H often grips the handle 37 to operate the work vehicle 10. According to the above configuration, the driver H can operate the rotation manual controller 41 by lowering his/her hand (right hand or left hand) from the handle 37. The operability of the rotation manual controller 41 is improved.

[2] The work vehicle 10 includes the operation panel 33 including the plurality of manual controllers 40 facing the driver H and operable by the driver H. The plurality of manual controllers 40 includes the rotation manual controller 41. The rotation manual controller 41 is one of the manual controllers 40 located outermost in the left-right direction on the operation panel 33 among the plurality of manual controllers 40.

According to the work vehicle 10 of [2], the operation of the rotation manual controller 41 is less likely to be disturbed by the other manual controllers 40 or operation devices.

[3] The work vehicle 10 includes the operation panel 33 including the plurality of manual controllers 40 facing the driver H and operable by the driver H. The plurality of manual controllers 40 includes the rotation manual controller 41. The rotation manual controller 41 includes the dial 411 and the push buttons 412 located adjacent to the dial 411. The push buttons 412 are located side by side adjacent to one side of the dial 411 in the left-right direction.

According to the work vehicle 10 of [3], when the driver H operates the rotation manual controller 41 with his/her hand, the dial 411 can be operated with the thumb and the index finger, and the push buttons 412 can be operated with the middle finger or the ring finger, so that the movement of his/her hand can be reduced.

[4] The work vehicle 10 includes the operation panel 33 including the plurality of manual controllers 40 facing the driver H and operable by the driver H. The operation panel 33 includes the display device 50. The plurality of manual controllers 40 includes the rotation manual controller 41. The rotation manual controller 41 is located on one side (for example, right side) in the left-right direction with respect to the display device 50 and closer to the driver H than the display device 50.

According to the work vehicle 10 of [4], the driver H can easily check both the display device 50 and the rotation manual controller 41. The driver H can easily operate the rotation manual controller 41 while visually recognizing the display device 50.

[5] In the work vehicle 10 including the rotation manual controller 41 and the display device 50, the operation panel 33 includes the first surface 331 on which the display device 50 is provided, and the second surface 332 that is located closer to the driver H than the first surface 331 and on which the rotation manual controller 41 is provided. Regarding the inclination angle θ using the horizontal plane P as a reference, the first surface 331 has a larger inclination angle than the second surface 332.

According to the work vehicle 10 of [5], the driver H can operate the rotation manual controller 41 with his/her hand relaxed while visually recognizing the display device 50.

[6] The work vehicle 10 includes the operation panel 33 including the plurality of manual controllers 40 facing the driver H and operable by the driver H. The plurality of manual controllers 40 includes the rotation manual controller 41. The rotation manual controller 41 is located at a position away from the steering shaft 38 (steering post 39) located at the center of the operation panel 33 in the left-right direction toward one side (for example, right side) in the left-right direction.

According to the work vehicle 10 of [6], the operation of the rotation manual controller 41 is less likely to be disturbed by the steering-related operation device.

[7] The work vehicle 10 includes the operation panel 33 including the plurality of manual controllers 40 facing the driver H and operable by the driver H. The plurality of manual controllers 40 includes the rotation manual controller 41. The rotation manual controller 41 has a function of performing an operation of adjusting the rotation speed of the drive assembly 22. The plurality of manual controllers 40 includes the cruise lever 42 to control a traveling speed. The rotation manual controller 41 and the cruise lever 42 are located in a region on one side (for example, right side) in the left-right direction with respect to the steering shaft 38 (steering post 39) located at the center of the operation panel 33 in the left-right direction.

According to the work vehicle 10 of [7], the manual controller 40 of the drive system (traveling system) is located in the region on one side in the left-right direction, and the operability is improved.

[8] The work vehicle 10 includes the operation panel 33 including the plurality of manual controllers 40 facing the driver H and operable by the driver H, and the handle 37 located closer to the driver H than the operation panel 33. The plurality of manual controllers 40 includes the on/off manual controller 43 to control on/off of the drive assembly 22. The on/off manual controller 43 is located in a region between the circumscribed circle of the handle 37 and the steering shaft 38 (steering post 39).

According to the work vehicle 10 of [8], the on/off manual controller 43 is located to be hidden by the handle 37. It is possible to reduce or prevent an erroneous operation of the on/off manual controller 43 during driving.

[9] The work vehicle 10 includes the operation panel 33 including the plurality of manual controllers 40 facing the driver H and operable by the driver H. The plurality of manual controllers 40 includes the rotation manual controller 41 and the on/off manual controller 43 to control on/off of the drive assembly 22. The on/off manual controller 43 is located closer to the driver H than the rotation manual controller 41.

According to the work vehicle 10 of [9], the on/off manual controller 43 is close to the driver H, and the on/off manual controller 43 can be operated in an emergency.

[10] The work vehicle 10 includes the operation panel 33 including the plurality of manual controllers 40 facing the driver H and operable by the driver H. The plurality of manual controllers 40 includes the rotation manual controller 41 and the on/off manual controller 43 to control on/off of the drive assembly 22. The on/off manual controller 43 is located closer to the steering shaft 38 (steering post 39) than the rotation manual controller 41.

According to the work vehicle 10 of [10], the on/off manual controller 43 is located to be hidden by the handle 37 connected to the steering shaft 38. It is possible to reduce or prevent an erroneous operation of the on/off manual controller 43 during driving.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A work vehicle comprising:
an operation panel facing a driver;
a steering post extending from the operation panel toward the driver;
a display device provided on the operation panel; and
a rotation manual controller provided on the operation panel and operable by the driver.

2. The work vehicle according to claim 1, wherein
the steering post is located closer to the driver than the display device; and
the rotation manual controller is located on one side of the steering post in a left-right direction.

3. The work vehicle according to claim 1, wherein
a different manual controller from the rotation manual controller is located on one side of the steering post in a left-right direction; and
the rotation manual controller is located farther from the steering post than the different manual controller.

4. The work vehicle according to claim 1, further comprising:
a handle provided on a tip portion side of the steering post; wherein
at least a portion of the rotation manual controller is located between a virtual vertical plane passing through one end of the handle in a left-right direction and spreading in a front-rear direction and one end of the operation panel in the left-right direction.

5. The work vehicle according to claim 1, wherein the rotation manual controller is usable to change a display operation of the display device.

6. The work vehicle according to claim 1, wherein the operation panel includes a plurality of manual controllers operable by the driver; and
the rotation manual controller is positioned outermost in a left-right direction on the operation panel among the plurality of manual controllers including the rotation manual controller.

7. The work vehicle according to claim 1, wherein the rotation manual controller includes a dial and push buttons located adjacent to the dial.

8. The work vehicle according to claim 7, wherein the push buttons are located side by side adjacent to one side of the dial in a left-right direction.

9. The work vehicle according to claim 1, wherein
the operation panel includes a first surface on which the display device is provided and a second surface that is located closer to the driver than the first surface and on which the rotation manual controller is provided; and
regarding an inclination angle using a horizontal plane as a reference, the first surface has a larger inclination angle than the second surface.

10. The work vehicle according to claim 1, wherein the rotation manual controller is located on one side in a left-right direction with respect to the display device and closer to the driver than the display device.

11. The work vehicle according to claim 1, wherein the rotation manual controller is located at a position to one side one side in a left-right direction of the steering post located at a center of the operation panel in a left-right direction.

12. The work vehicle according to claim 1, further comprising:
a second manual controller provided on the operation panel and different from the rotation manual controller; wherein
the second manual controller is located in a region of the operation panel on one side in a left-right direction with respect to the steering post; and
the rotation manual controller is closer to the display device than the second manual controller.

13. The work vehicle according to claim 1, further comprising:
a cruise lever provided on the operation panel and configured to control a traveling speed; wherein
the rotation manual controller has a function of performing an operation of adjusting a rotation speed of a drive assembly; and
the rotation manual controller and the cruise lever are located in a region on one side in a left-right direction with respect to the steering post located at a center of the operation panel in a left-right direction.

14. The work vehicle according to claim 13, further comprising:
an on/off manual controller provided on the operation panel and configured to control on/off of the drive assembly;
the on/off manual controller is located in the region on one side in the left-right direction.

15. The work vehicle according to claim 1, further comprising:
an on/off manual controller provided on the operation panel and configured to control on/off of a drive assembly; wherein
when viewed from a direction orthogonal to the operation panel, the on/off manual controller is located in a region between a circumscribed circle of a handle provided on a tip portion side of the steering post and the steering post.

16. The work vehicle according to claim 1, further comprising:
an on/off manual controller provided on the operation panel and configured to control on/off of a drive assembly; wherein
the on/off manual controller is located closer to a driver than the rotation manual controller.

17. The work vehicle according to claim 1, further comprising:
an on/off manual controller provided on the operation panel and configured to control on/off of a drive assembly; wherein
the on/off manual controller is located closer to the steering post than the rotation manual controller.
